(19) United States
(12) Patent Application Publication
(10) Pub. No.: US 2025/0042311 A1
(43) Pub. Date: Feb. 6, 2025

(54) SLIDING DEVICE

(71) Applicant: DELTA KOGYO CO., LTD., Hiroshima (JP)

(72) Inventors: Ryo ONIKI, Hiroshima (JP); Yuu INASAKO, Hiroshima (JP); Yuji IKEDA, Hiroshima (JP)

(73) Assignee: DELTA KOGYO CO., LTD., Hiroshima (JP)

(21) Appl. No.: 18/720,425

(22) PCT Filed: Nov. 21, 2022
(86) PCT No.: PCT/JP2022/043058

§ 371 Date: Jun. 14, 2024

(30) Foreign Application Priority Data
Dec. 21, 2021 (JP) 2021-207324
Jan. 19, 2022 (JP) 2022-006542

(51) Int. Cl. B60N 2/07

(52) U.S. Cl. CPC B60N 2/0705

(57) ABSTRACT

A sliding device includes: lower balls arranged in a lower gap between a lower rail and an upper rail; an upper ball arranged in an upper gap; a first retainer arranged in the lower gap being one of the lower gap and the upper gap. The first retainer includes: a pair of first ball holding parts and a pair of second ball holding parts provided at the opposite ends of a main body for respectively holding the lower balls in a rollable manner; a pair of connection parts each connecting corresponding one of the first ball holding parts and corresponding one of the second ball holding parts to each other. The upper ball is arranged, in the upper gap, in a region corresponding to a predetermined distance between the two lower balls respectively held by the first ball holding part and the second ball holding part.

### TECHNICAL FIELD

The present invention relates to a sliding device for supporting a seat slidably and locking the seat in a desired position.

### BACKGROUND ART

A sliding device for supporting a seat slidably in a front-rear direction and locking the seat in a desired position has been conventionally and widely adopted in an automobile seat.

Such a sliding device includes, for example, a structure described in Patent Literature 1. As illustrated in FIG. 9, a sliding device 70 includes: a lower rail 50 to be fixedly attached to a floor surface of an automobile in a front-rear direction X of a seat; and an upper rail 60 to be fixedly attached to the seat and guided by the lower rail 50 movably in the front-rear direction X. A left and right pair of the sliding devices 70 are arranged downward Z2 of the seat and apart from each other in a width direction Y.

The lower rail 50 is a member extending in the front-rear direction X with the opposite leading ends bent inward in a U-shape opening upward Z1 in a cross-section. Specifically, the lower rail 50 has a bottom wall 51 that is a flat plate extending in the front-rear direction X to be fixedly attached to the floor surface, a pair of outer walls 52 standing upward Z1 respectively from the opposite edges of the bottom wall 51, a pair of upper walls 53 extending from respective upper edges of the pair of outer walls 52 toward the center in the width direction Y of the lower rail 50, and a pair of inner walls 54 extending downward Z2 from respective ends of the pair of upper walls 53 that are closer to the center in the width direction Y. Each of the inner walls 54 has a plurality of engagement claws 55.

The upper rail 60 is a member extending in the front-rear direction X with the opposite leading ends bent outward in a U-shape opening downward Z2 in a cross-section. Specifically, the upper rail 60 has a top wall 61 that is a flat plate extending in the front-rear direction X to be fixedly attached to the seat, a pair of side walls 62 extending downward Z2 from the opposite edges of the top wall 61, a pair of bent parts 63 bent outward in the width direction Y of the upper rail 60 from respective lower edges of the pair of side walls 62. The upper rail 60 is attached to the lower rail 50 in such a manner that each of the pair of bent parts 63 is located in a space defined among the associated outer wall 52, the associated upper wall 53, and the associated inner wall 54 of the lower rail 50.

The sliding device includes a plurality of balls 72, 74 that support the upper rail 60 movably in the front-rear direction X, and retainers 71, 73 each having a rod shape to keep a distance between the associated balls in the front-rear direction X. Specifically, a rail lower gap between the lower rail 50 and the upper rail 60, that is, a rail gap 75 (see FIG. 10) between: a connection portion of the bottom wall 51 and the outer wall 52 of the lower rail 50; and the bent part 63 of the upper rail 60 accommodates a lower retainer 71 and at least one pair (two pairs in FIG. 9) of lower balls 72 located adjacent to each other in the front-rear direction X at each of the opposite ends of the lower retainer 71 in the front-rear direction X. Similarly, an upper rail gap between the lower rail 50 and the upper rail 60, that is, a rail gap 76 (see FIG. 10) between: a connection portion of the outer wall 52 and the upper wall 53 of the lower rail 50; and the bent part 63 of the upper rail 60 accommodates an upper retainer 73 and at least one pair (two pairs in FIG. 9) of upper balls 74 located adjacent to each other in the front-rear direction X at each of the opposite ends of the upper retainer 73 in the front-rear direction X.

In the sliding device 70 including the lower rail 50 and the upper rail 60 having the configuration as described above, the lower rail 50 or the upper rail 60 may have a variation in a dimension of the cross-sectional shape thereof and each of the upper and lower rail gaps 75, 76 may have an area which is wider, even a little, due to a machining error of the lower rail 50 or the upper rail 60, or other reason. In the wider area, the upper balls 74 or the lower balls 72 may remain without rolling in a movement of the upper rail 60, and the balls and the retainer may delay reaching their respective regular positions. In this case, the upper balls 74 or the lower balls 72 come into contact with ball stopper structures respectively provided at the opposite ends of the upper rail 60 in the front-rear direction X before reaching stroke ends. This leads to a disadvantage of a substantial decrease in a movement range of the upper rail 60.

The disadvantage will be discussed in further detail with reference to explanatory views of FIG. 11 to FIG. 12. FIG. 12 shows an example including only a pair of front and rear lower balls 72 and a pair of front and rear upper balls 74 to simplify the drawing.

First, in an initial state of the sliding device, the upper rail 60 is at the same position as the lower rail 50 in the front-rear direction X in such a manner that a rear end of the upper rail 60 is at a rear end stop position A1 as shown in a stage (a) of FIG. 11. At this time, each of the lower retainer 71 and the upper retainer 73 is at a base position shown in the stage (a) of FIG. 11 and a stage (a) of FIG. 12, that is, a rear end of each of the retainers 71, 73 is close to a rear end stopper position P1.

When the sliding device works regularly, the upper rail 60 is movable in the front-rear direction X in a regular rail movement range L1, i.e., a range between the rear end stop position A1 and a front end stop position A2, as shown in stages (b) and (c) of FIG. 11. The lower retainer 71 and the upper retainer 73 are integrally movable in the front-rear direction X in a regular retainer movable range R1, i.e., a range between the rear end stopper position P1 and a front end stopper position P2, as shown in stages (b) and (c) of FIG. 11 and stages (b) and (c) of FIG. 12. The pair of front and rear upper balls 72 roll in adjacent to the lower retainer 71 and the pair of front and rear upper balls 74 roll in adjacent to the upper retainer 73 in the front-rear direction X within the range R1.

However, as shown in a stage (d) of FIG. 11 and a stage (d) of FIG. 12, the lower rail gap 75 (see FIG. 10) has, for example, a variation in the dimension of a rail cross-sectional shape, and this hinders a lower ball 72B located rearward X2 from moving frontward X1 and the ball stops at a certain position. The lower retainer 71 being pushed frontward X1 by the lower ball 72B also stops moving. As a result, both the lower ball 72B and the lower retainer 71 are left behind a lower ball 72A located frontward X1 and having regularly rolled.

In this state, as shown in the stage (d) of FIG. 11, the lower retainer 71 is movable in the front-rear direction X only within an irregular retainer movement range R2 which is narrower than the regular retainer movement range R1. The upper rail 60 is accordingly movable in the front-rear direction X only within an irregular rail movement range L2 which is narrower than the regular rail movement range L1.

In returning the upper rail 60 rearward X2 as shown in the stage (d) of FIG. 11 and the stage (d) of FIG. 12 after the above-described irregular frontward movement, the lower ball 72B located rearward X2 stays further rearward X2 than a position which the ball would have reached if the ball had regularly rolled frontward X1 (the stage (b) of FIG. 11 and the stage (b) of FIG. 12). The lower ball 72B thus reaches the rear end stopper position P1 of the lower retainer 71 before the upper rail 60 reaches the base position (the stage (a) of FIG. 11 and the stage (a) of FIG. 12), that is, the upper rail 60 is movable only within the irregular movable range L2. To restore the sliding device to a regular state, it is required to return the upper rail 60 to a target position by applying a larger load to the upper rail 60 than a load applied in regular working, and compulsorily making the upper rail 60 and the ball slide relative to each other. In this case, a large force is required to move the upper rail 60. The requirement leads to a disadvantage that an occupant having a small body size may fail to satisfactorily move the upper rail due to the lack of power, which results in a substantial reduction in the stroke amount of the sliding device.

In this regard, a possible configuration may include the upper balls 74 held in a rollable manner respectively at the opposite ends of the upper retainer 73 in the front-rear direction X and the lower balls 72 held in a rollable manner respectively at the opposite ends of the lower retainer 71 in the front-rear direction X to prevent misalignment of the upper balls 74 and the lower balls 72. However, this configuration makes the sliding device complicated as a whole, and thus still remains in the need of improvement.

### CITATION LIST

### Patent Literature

Patent Literature 1: Japanese Patent Publication Number 6492876

### SUMMARY OF INVENTION

The present invention has been achieved in view of the circumstances described above, and has an object of providing a sliding device that has a simple configuration and enables prevention of misalignment of a ball.

To solve the disadvantages described above, a sliding device in the present invention is a sliding device for supporting a seat slidably. The sliding device includes: a lower rail that is a long member to be fixedly attached to a mount surface over which the seat is arranged; an upper rail that has a portion to be fixedly attached to the seat, is movably guided by the lower rail in a longitudinal direction of the lower rail, and defines an upper gap extending in the longitudinal direction and a lower gap extending in the longitudinal direction below the upper gap in combination with the lower rail; a plurality of lower balls arranged in the lower gap between the lower rail and the upper rail and being rollable in coincidence with a movement of the upper rail; a plurality of upper balls arranged in the upper gap between the lower rail and the upper rail and being rollable in coincidence with a movement of the upper rail; and a first retainer arranged in a first gap being one of the lower gap and the upper gap. The first retainer includes: a main body having a length; a pair of first ball holding parts located at the opposite ends of the main body in a longitudinal direction of the main body for holding first balls, respectively, the first ball being one of the lower ball and the upper ball arranged in the first gap; a pair of second ball holding parts respectively corresponding to the pair of first ball holding parts, the second ball holding part being located further than the first ball holding part with respect to the main body and holding a first ball in a rollable manner; and a pair of connection parts each connecting corresponding one of the pair of first ball holding parts and corresponding one of the pair of second ball holding parts to each other to keep a distance between the center of the first ball held by the first ball holding part and the center of the first ball held by the second ball holding part at a predetermined distance. At least one second ball is arranged in a second gap which is the other of the lower gap and the upper gap and in which the first retainer is not arranged, the second ball being the other of the upper ball and the lower ball and being arranged in a region corresponding to the predetermined distance between the two first balls at each of the opposite ends of the first retainer in the first gap.

### BRIEF DESCRIPTION OF DRAWINGS

FIG. 1 is an overall perspective view of a structure of two sliding devices attached to a lower surface of a seat, according to an embodiment of the present invention.

FIG. 2 is an overall perspective view of each of the sliding devices shown in FIG. 1.

FIG. 3 is a cross-sectional view taken along the line III-III in FIG. 2.

FIG. 4 is an exploded perspective view of the sliding device in FIG. 2.

FIG. 5 is a perspective view of a first retainer in FIG. 4.

FIG. 6 is an explanatory view schematically illustrating an arrangement of the first retainer, four lower balls, and two upper balls in the sliding device in FIG. 2.

FIG. 7 is an enlarged view of a front area of the first retainer in FIG. 6 and illustrates an arrangement of the first retainer and two lower balls in a lower gap and one upper ball in an upper gap.

FIG. 8 is an explanatory view showing a modification of the sliding device in the present invention, and schematically illustrating a structure additionally including a second retainer between two upper balls in the sliding device in FIG. 6 and an arrangement of a first retainer, the second retainer, four lower balls, and the two upper balls.

FIG. 9 is an exploded perspective view of a conventional sliding device.

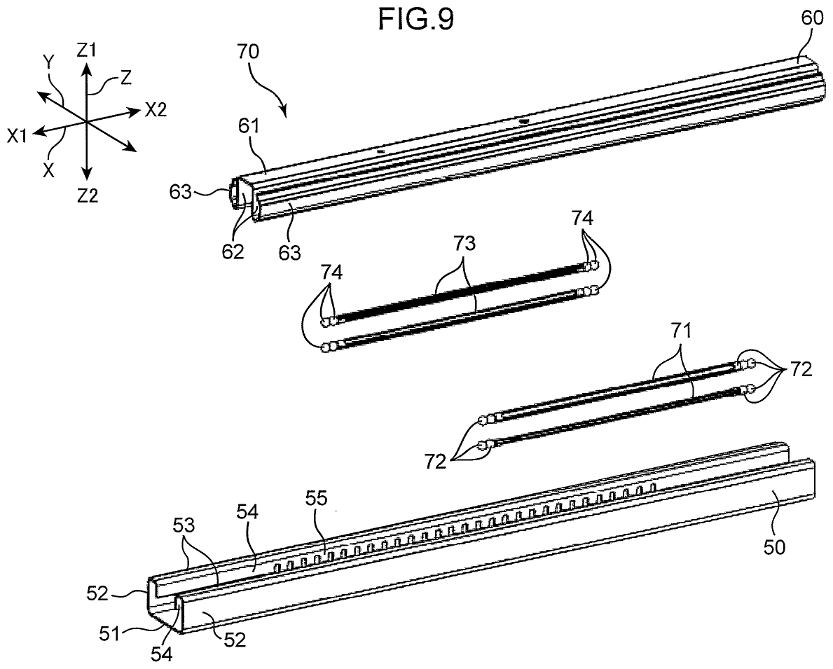

FIG. 10 is an enlarged view of a front area of a lower retainer and an upper retainer in FIG. 9 and illustrates an arrangement of the lower retainer and two lower balls in a lower gap and an arrangement of the upper retainer and two upper balls in an upper gap.

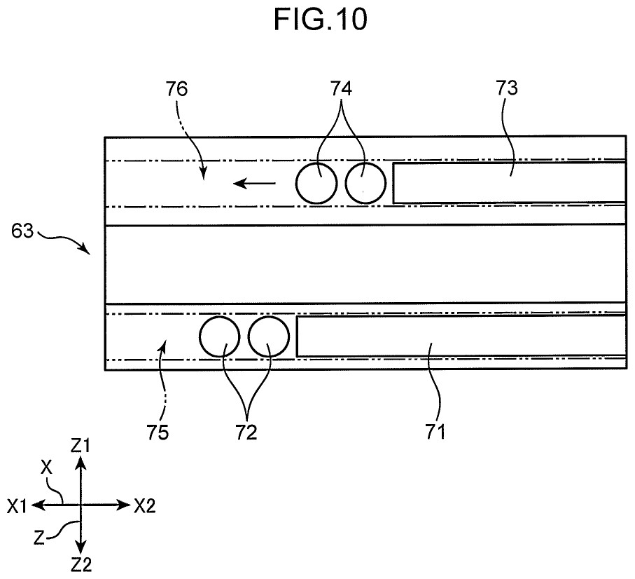

FIG. 11 is an explanatory view schematically illustrating a movement of each of an upper rail, the upper retainer, and the lower retainer in the sliding device in FIG. 9.

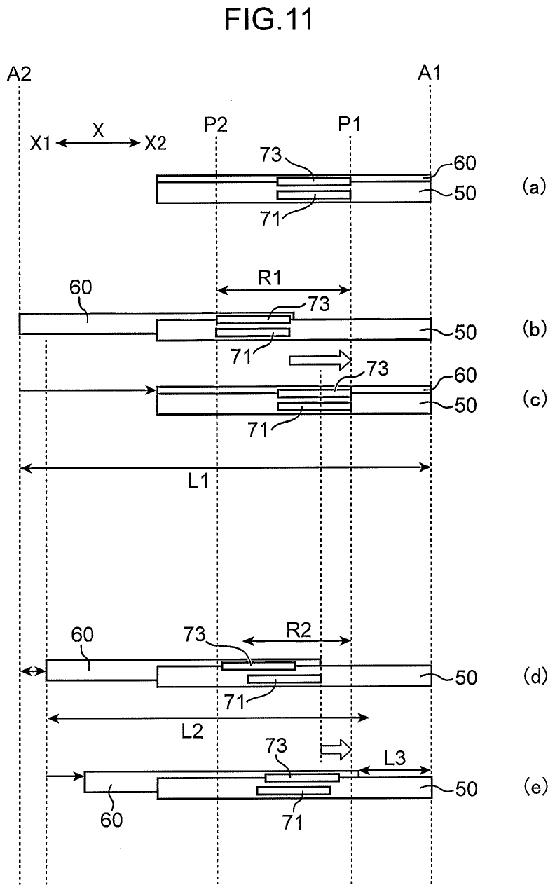

FIG. 12 is an explanatory view schematically illustrating a movement of each of the upper retainer and the lower retainer in FIG. 11, and a movement of each of the upper balls and the lower balls.

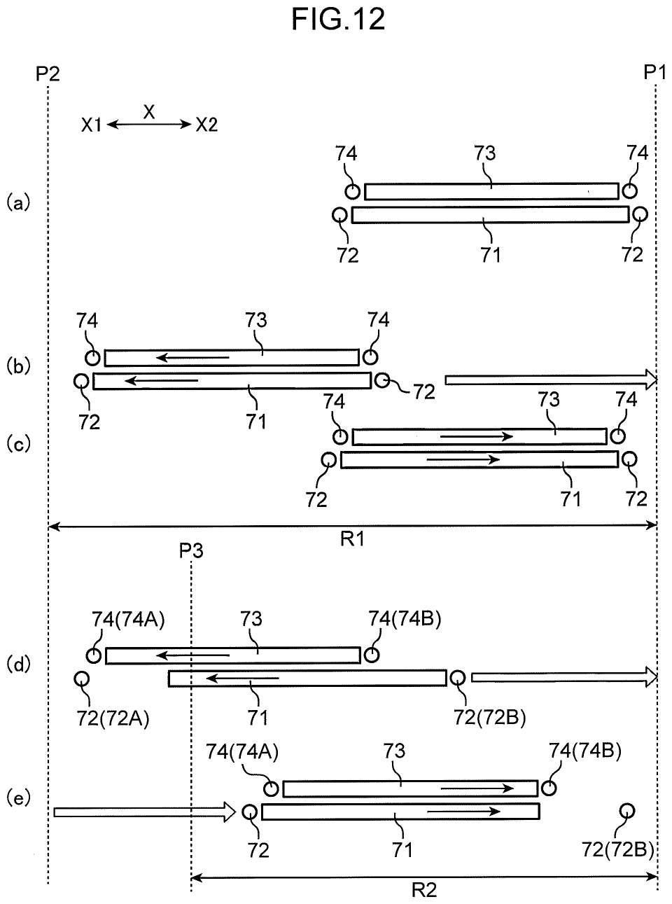

### DESCRIPTION OF EMBODIMENTS

Hereinafter, a preferable embodiment of a sliding device of the present invention will be described with reference to the accompanying drawings.

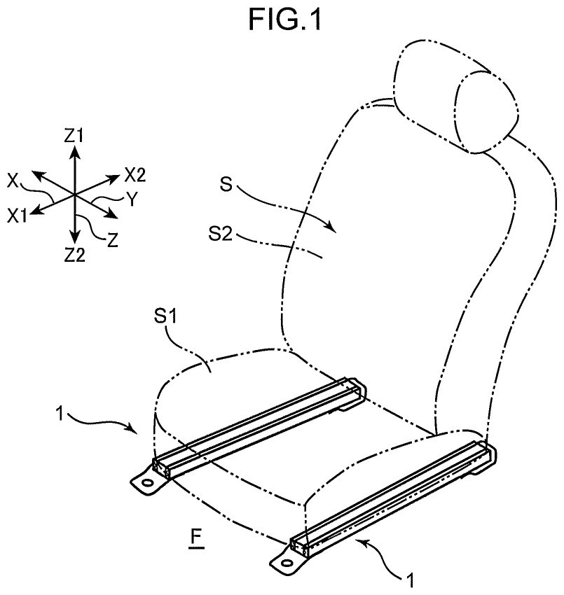

A sliding device 1 according to the embodiment is, for example, a device for supporting a seat S to be used as a seat for an automobile slidably in a front-rear direction X as shown in FIG. 1. The seat S includes a seat cushion S1 and a seatback S2 standing upward from a rear portion of the seat cushion S1. A pair of the sliding devices 1 extend in the front-rear direction X, are apart from each other in a width direction Y, and are located between a lower surface of the seat cushion S1 and a floor surface F of the automobile. The sliding devices 1 in the present invention may be arranged in a left-right direction or width direction for allowing the seat S to move in the left-right direction without limitation to the arrangement in the front-rear direction of the seat S.

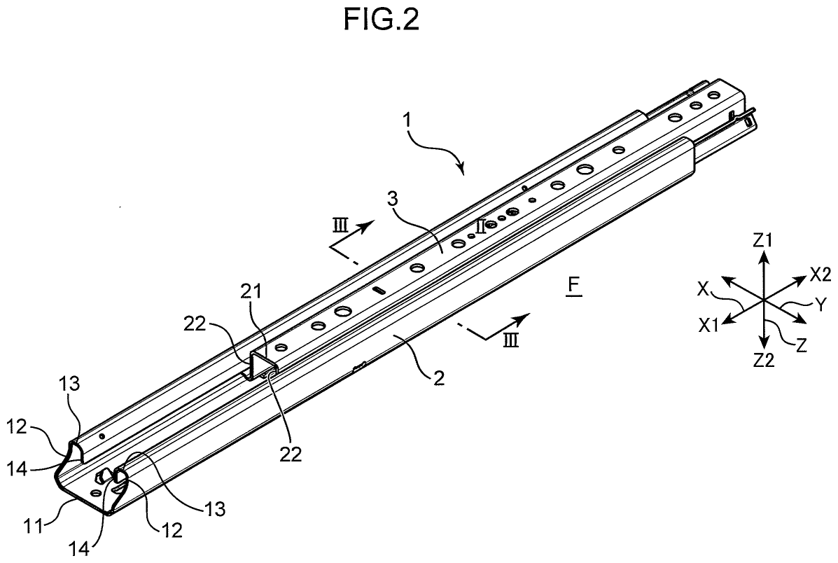

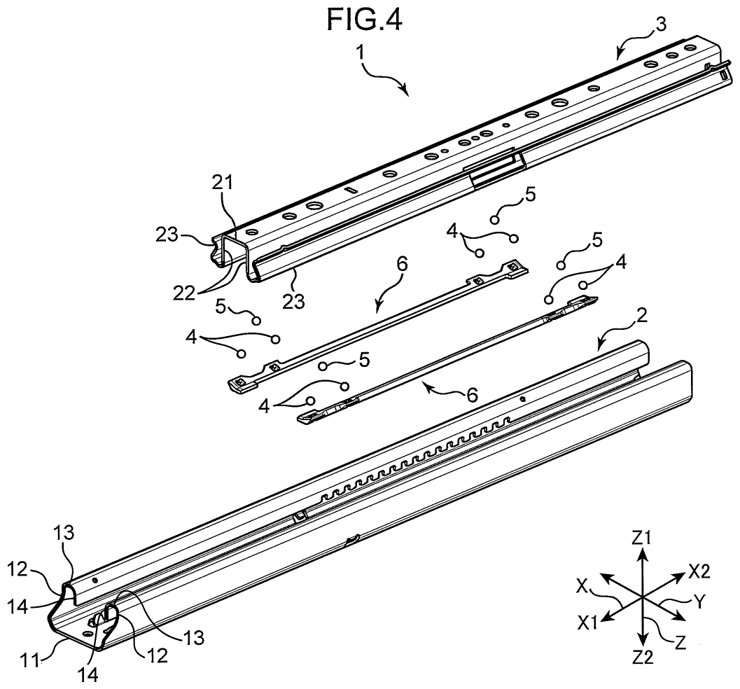

As shown in FIG. 2 to FIG. 4, each of the sliding devices 1 includes a lower rail 2, an upper rail 3 slidably combined with the lower rail 2, a plurality of lower balls 4 and a plurality of upper balls 5 that support the upper rail 3 slidably, and a first retainer 6 that retains the lower balls 4 in a rollable manner. In the embodiment, the first retainer 6 retains four lower balls 4 in total, that is, two lower balls at a front end and two lower balls at a rear end thereof. Each upper ball 5 is arranged in a region corresponding to a region between the two lower balls 4 at each of the front and rear opposite ends of the first retainer 6 in the front-rear direction X without being retained by a retainer.

The lower rail 2 is a long member extending in the front-rear direction X to be fixedly attached to the floor surface F of the automobile. Specifically, the lower rail 2 has a bottom wall 11 that is a flat plate extending in the front-rear direction X to be fixedly attached to the floor surface, a pair of outer walls 12 standing upward Z1 from the opposite edges of the bottom wall 11, a pair of upper walls 13 extending from respective upper edges of the pair of outer walls 12 toward the center in the width direction Y of the lower rail 2, and a pair of inner walls 14 extending downward Z2 from respective ends of the pair of upper walls 13 that are closer to the center in the width direction Y. The bottom wall 11, the pair of outer walls 12, the pair of upper walls 13, and the pair of inner walls 14 define a pair of spaces 15 each extending in the front-rear direction X.

The upper rail 3 is configured to be fixedly attached to the lower surface of the seat cushion S1 of the seat S and movably guided by the lower rail 2 in the front-rear direction X or in a longitudinal direction of the lower rail 3. The upper rail 3 is further configured to define an upper gap 42 extending in the front-rear direction X and a lower gap 41 extending in the front-rear direction X downward Z2 of or below the upper gap 42 in combination with the lower rail, the gaps being described later.

The upper rail 3 is locked in an appropriate position by a lock mechanism (not shown) incorporated in the upper rail 3.

Specifically, the upper rail 3 has a top wall 21 that is a flat plate extending in the front-rear direction X to be fixedly attached to the seat S, a pair of side walls 22 extending downward Z2 from the opposite edges of the top wall 21, and a pair of bent parts 23 bent outward in the width direction Y of the upper rail 3 from respective lower edges of the pair of side walls 22. The pair of bent parts 23 are respectively disposed in the pair of spaces 15 of the lower rail 2.

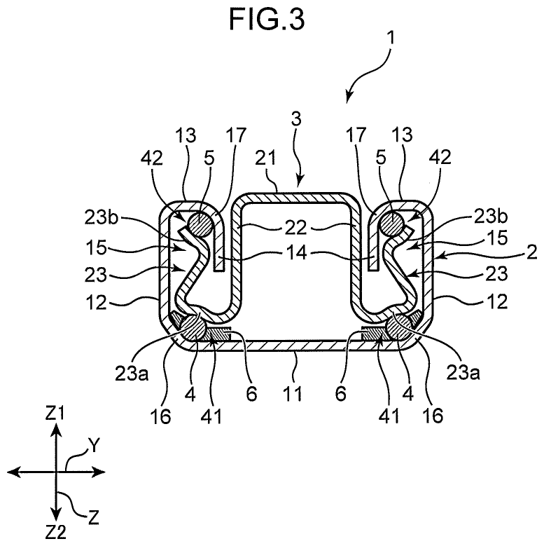

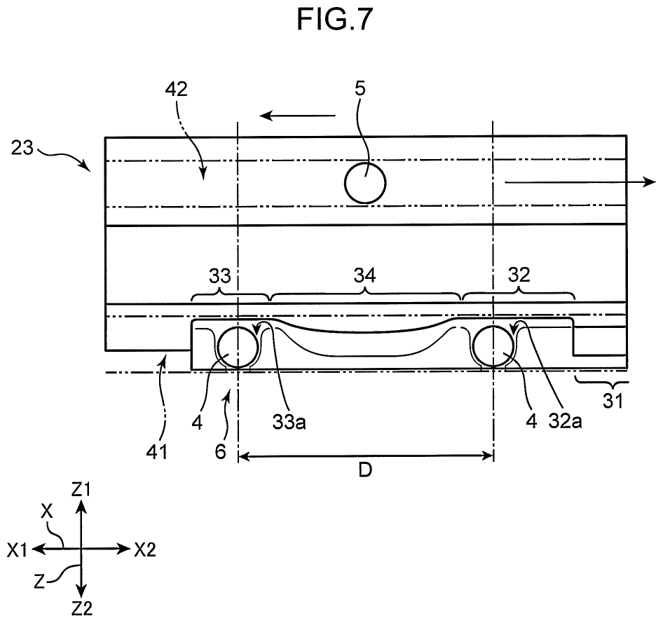

As shown in FIG. 3, each of the pair of bent parts 23 has a lower portion 23a having an outer surface curving upward Z1 in a U-shape to come into contact with the corresponding lower ball 4, and an upper portion 23b having an upper surface curving inward in an L-shape in the width direction as advancing upward from the lower portion 23a and then curving outward in the width direction to come into contact with the corresponding upper ball 5. As shown in FIG. 3 and FIG. 7, the lower gap 41 is defined between: the lower portion 23a of the bent part 23; and a connection portion 16 of the bottom wall 11 and the outer wall 12. The upper gap 42 is defined between: the upper portion 23b of the bent part 23; and a connection portion 17 of the inner wall 14 and the upper wall 13.

The lower balls 4 are arranged in the lower gap 41 (see FIG. 3 and FIG. 7) between the connection portion 16 and the lower portion 23a of the bent part 23 and are rollable in coincidence with a movement of the upper rail 3 in the front-rear direction X.

The upper balls 5 are arranged in the upper gap 42 (see FIG. 3 and FIG. 7) between the connection portion 17 and the upper portion 23b of the bent part 23 and are rollable in coincidence with a movement of the upper rail 3 in the front-rear direction X.

The upper gap 42 in which the upper balls 5 are arranged may be defined by at least the upper wall 13 and the bent part 23. Although the upper portion 23b of the bent part 23 curves outward in the width direction Y, and hence, the upper gap 42 is defined between: the connection portion 17 of the inner wall 14 and the upper wall 13; and the upper portion 23b of the bent part 23 in the embodiment as shown in FIG. 3, the present invention is not limited thereto. For instance, any configuration in which the upper portion 23b of the bent part 23 is bent inward in the width direction Y provides the upper gap 42 defined between: a connection portion of the outer wall 12 and the upper wall 13; and the upper portion 23b of the bent part 23.

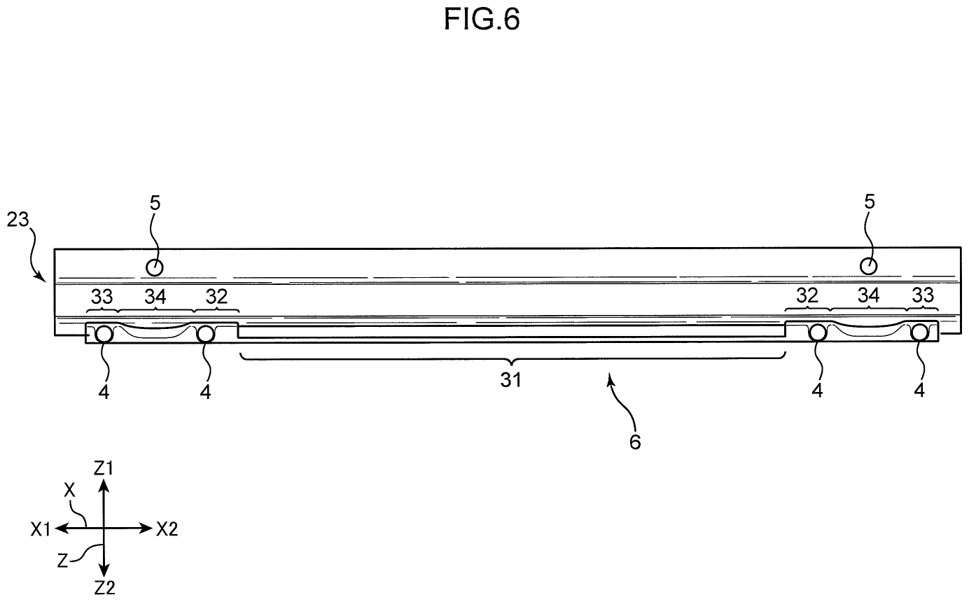

The first retainer 6 is arranged in one (first gap) of the lower gap 41 and the upper gap 42. In the embodiment, the first retainer 6 is arranged in the lower gap 41 serving as the first gap as shown in FIG. 3 to FIG. 4 and FIG. 6 to FIG. 7. The upper balls 5 arranged in the upper gap 42 and the lower balls 4 arranged in the lower gap 41 are hidden by the rails 1, 2, and the upper balls 5 and the lower balls 4 are invisible in reality and thus should be denoted by dashed lines. However, the balls 4, 5 are denoted by solid lines in FIG. 6 to FIG. 7 to emphasize their respective positions.

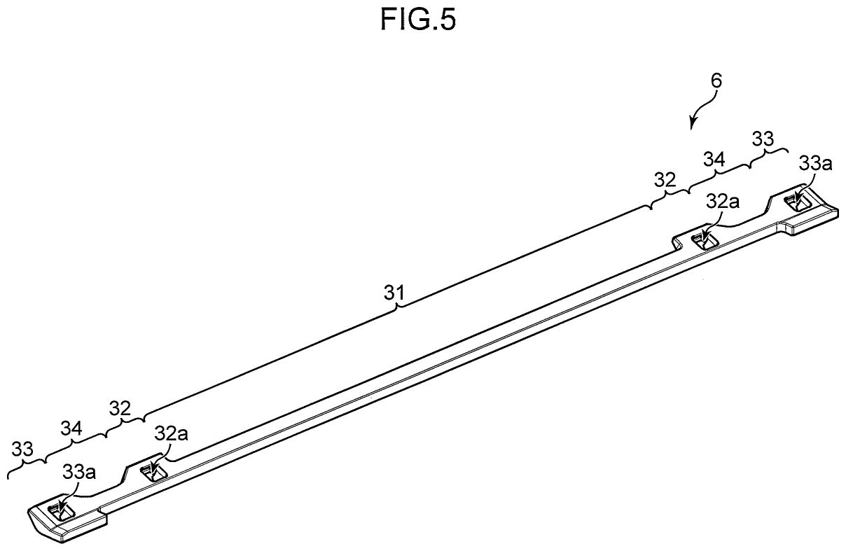

As shown in FIG. 5 to FIG. 7, the first retainer 6 includes a main body 31 extending in the front-rear direction X and three parts at each of the opposite ends of the main body 31 in the front-rear direction, specifically, a pair of first ball holding parts 32, a pair of second ball holding parts 33, and a pair of connection parts 34. A shape of the entire first retainer 6 is not particularly limited in the present invention. The first retainer 6 may have a rectangular plate shape extending with the same width in the longitudinal direction of the first retainer 6 without limitation to such a shape that the main body 31 and each connection part 34 are narrower than each first ball holding part 32 and each second ball holding part 33 as shown in FIG. 5.

Each of the pair of first ball holding parts 32 holds a lower ball 4 in a rollable manner in the embodiment as a first ball being one of the lower ball 4 and the upper ball 5, the first ball being a held ball to be held by each of the first ball holding part 32 and the second ball holding part 33. For instance, the first ball holding part 32 has a holding hole 32a for holding a corresponding lower ball 4 in a rollable manner.

The pair of second ball holding parts 33 correspond to the pair of first ball holding parts 32, the second ball holding part 33 being located further than the first ball holding part 32 with respect to the main body 31. In the embodiment, each of the second ball holding parts 33 holds a corresponding lower ball 4 or first ball in a rollable manner. Each second ball holding part 33 has, for example, a holding hole 33a like the holding hole of the first ball holding part 32.

Each of the connection parts 34 connects corresponding one of the pair of first ball holding parts 32 and corresponding one of the pair of second ball holding parts 33 to each other to keep a distance between the center of the lower ball 4 held by the first ball holding part 32 and the center of the lower ball 4 held by the second ball holding part 33 at a predetermined distance D (see FIG. 7).

As shown in FIG. 7, in the embodiment, the predetermined distance D allows each upper ball 5 arranged in the upper gap 42 that is a second gap being the other of the lower gap 41 and the upper gap 42 in which the first retainer 6 is not arranged to roll in the front-rear direction X, the upper ball 5 being a second ball, i.e., a non-held ball in a free state of being not held by each of the first ball holding part 32 and the second ball holding part 33. The predetermined distance D is preferably equal to or longer than an alignment length of two upper balls 5.

As shown in FIG. 6 to FIG. 7, in the embodiment, at least one upper ball 5 or second ball is arranged, in the upper gap 42, in a region corresponding to the predetermined distance D between the two lower balls 4 in the front-rear direction X.

Specifically, the sliding device 1 in the embodiment has such a simple configuration that the upper ball 5 or second ball is arranged in the region corresponding to the predetermined distance D between the two lower balls 4 or first balls without a retainer for retaining the upper ball 5 in a rollable manner.

### Characteristics of the Embodiment

(1) As described heretofore, the sliding device 1 in the embodiment includes the first retainer 6 arranged in the lower gap 41 or first gap as shown in FIG. 7.

As shown in FIG. 5 to FIG. 7, the first retainer 6 includes: the main body 31 having a length to extend in the front-rear direction X; a pair of first ball holding parts 32 located at the opposite ends of the main body 31 in the front-rear direction X or in a longitudinal direction of the main body 31 for holding lower balls 4 respectively in a rollable manner; a pair of second ball holding parts 33 respectively corresponding to the pair of first ball holding parts 32, the second ball holding part 33 being located further than the first ball holding part 32 with respect to the main body 31; and a pair of connection parts 34. Each of the pair of connection parts 34 connects each of the opposite ends of corresponding one of the pair of first ball holding parts 32 and corresponding one of the pair of second ball holding parts 33 to each other to keep a distance between the center of the lower ball 4 or first ball held by the first ball holding part 32 and the center of the lower ball 4 or first ball held by the second ball holding part 33 at the predetermined distance D (see FIG. 7).

As shown in FIG. 6 to FIG. 7, an upper ball 5 or second ball is arranged, in the upper gap 42 or second gap in which the first retainer 6 is not arranged, in a region corresponding to the predetermined distance D between the two lower balls 4 in the front-rear direction X.

The sliding device 1 has a configuration that allows the upper ball 5 or second ball arranged in the upper gap 42 or second gap in which the first retainer 6 is not arranged to stay in the region corresponding to the predetermined distance D without retaining the upper ball 5 by a retainer or other member, and accordingly enables prevention of misalignment of the upper ball 5 with the simple configuration.

Specifically, in this configuration, the first retainer 6 is arranged in the lower gap 41 defined by the lower rail 2 and the upper rail 3. The two lower balls 4 respectively held by the first ball holding part 32 and the second ball holding part 33 at each of the opposite ends of the first retainer 6 support the lower rail 2 and the upper rail 3. Hence, each of the lower rail 2 and the upper rail 3 has high stiffness in a cross-section in portions supported by the two lower balls 4. Besides, the portions supported by the two lower balls 4 exert the high stiffness in the cross-section in the upper gap 42 in which the first retainer 6 is not arranged. The upper ball 5 arranged in the upper gap 42 in a free state of not being retained by the first retainer 6 is less likely to roll onto the same cross-sectional plane as that of the lower balls 4 respectively held by the first ball holding part 32 and the second ball holding part 33 in the front-rear direction X, that is, is less likely to roll to the same position in the longitudinal direction of the lower rail 2 or in the front-rear direction X, from the perspective of the property of a ball which has a tendency to roll to a portion having lower stiffness in a cross-section of a rail in a sliding device. By contrast, the lower rail 2 and the upper rail 3 are not supported by the two lower balls 4 in the region corresponding to the predetermined distance D between the two lower balls 4 respectively held by the first ball holding part 32 and the second ball holding part 33 connected by the connection part 34 to each other, and has low stiffness in a cross-section in the upper gap 42. The upper ball 5 in the free state hence has a tendency to stay in the region corresponding to the predetermined distance D of the connection part 34. In this configuration, once the upper ball 5 in the free state has been arranged at a position in a region corresponding to the region between the two lower balls 4 respectively held by the first ball holding part 32 and the second ball holding part 33 in the front-rear direction X, the upper ball 5 has a tendency to stay, in the upper gap 42, in the region corresponding to the predetermined distance D between the two lower balls 4. This results in eliminating the need for a retainer, and the sliding device 1 thus has a simple configuration and enables prevention of misalignment of both the lower balls 4 and the upper ball 5.

(2) A configuration including a first retainer 6 not in a lower gap 41 but in an upper gap 42 can exert the same operational effect as the operational effect described in (1) above. In this configuration, the first retainer 6 is arranged in the upper gap 42, and a first ball holding part 32 and a second ball holding part 33 of the first retainer 6 hold upper balls 5 respectively. By contrast, at least one lower ball 4 in a free state is arranged, in the lower gap 41, in a region corresponding to a region between the two upper balls 5 in the front-rear direction X. In this configuration, the lower ball 4 in a free state has a tendency to stay, in the lower gap 41, in the region corresponding to a predetermined distance D between the two upper balls 5. This results in eliminating the need for a retainer, and the sliding device 1 thus has a simple configuration and enables prevention of misalignment of the lower ball 4.

(3) The sliding device 1 in the embodiment configured to include only the first retainer 6 enables prevention of misalignment of both the lower ball 4 and the upper ball 5. The sliding device 1 has a simpler configuration with a smaller number of components at a lower manufacturing cost than a configuration in which both the lower gap 41 and the upper gap 42 accommodate retainers respectively. Further, a weight reduction in the sliding device 1 is achieved.

(4) In the sliding device 1 in the embodiment, the predetermined distance D allows the upper ball 5 arranged in the upper gap 42 to travel in the front-rear direction X.

In this configuration, the upper ball 5 in the free state that is arranged in the upper gap 42 in which the first retainer 6 is not arranged has a tendency to stay at the center position between the two lower balls 4 respectively held by the first ball holding part 32 and the second ball holding part 33, in the upper gap 42, in the region corresponding to the predetermined distance D between the two lower balls 4. This configuration thus can restrict the displacement of the upper ball 5 without providing the retainer in the upper gap 2.

(5) In the sliding device 1 in the embodiment, the predetermined distance D is preferably equal to or longer than an alignment length of two upper balls 5.

Even when a specific portion has a variation in a component accuracy, this configuration attains a steady force to be applied in a sliding operation by allowing each of the upper balls 5 to leave the specific portion having the variation. The upper ball 5 in the free state that is arranged in the upper gap 42 in which the first retainer 6 is not arranged has an increased degree of freedom of displacement in the front-rear direction X, in the upper gap 42, in the region corresponding to the predetermined distance D between the two lower balls 4 respectively held by the first ball holding part 32 and the second ball holding part 33. This allows the upper ball 5 in the free state to surely stay as it is.

This configuration further enables an arrangement of two or more upper balls 5 in the free state and achieves an increase in the degree of freedom for designing the sliding device 1.

(6) In the sliding device 1 in the embodiment, the first retainer 6 is arranged in the lower gap 41. In this configuration, the first ball holding part 32 and the second ball holding part 33 at each of the opposite ends of the first retainer 6 hold lower balls 4 being first balls respectively. The single first retainer 6 can stably receive downward loads from the upper rail 3 via four lower balls 4 in total. This consequently allows the upper rail 3 to stably move in the front-rear direction X.

(7) In the sliding device 1 in the embodiment, as shown in FIG. 7, two lower balls 4 and one upper ball 5 are arranged to form a triangle and thus can stably hold the upper and lower rails 2, 3.

The arrangement of the upper ball 5 and the lower balls 4 at different positions from one another in the front-rear direction X increases a degree of freedom for a selection of a ball diameter of each of the upper ball 5 and the lower balls 4 and a way of fitting each ball.

(8) In assembling the upper rail 3 and the lower rail 2 to each other to constitute the sliding device 1 in the embodiment, the lower balls 4, the first retainer 6, and the upper rail 3 are simultaneously inserted into to the lower rail 2 from the rear of the lower rail 2 to be assembled thereto, and thereafter, the front upper ball 5 is insertable into the assembly from the front thereof and the rear upper ball 5 is insertable into the assembly from the rear thereof. The way enables assembling of the first retainer 6 without any burden to the retainer attributed to shifting of the ball in the assembling. This makes it possible to prevent the first retainer 6 from being damaged in the assembling. Therefore, a resin retainer having been widespread in recent years is adoptable for the first retainer 6 without a risk of such a damage.

### Modifications

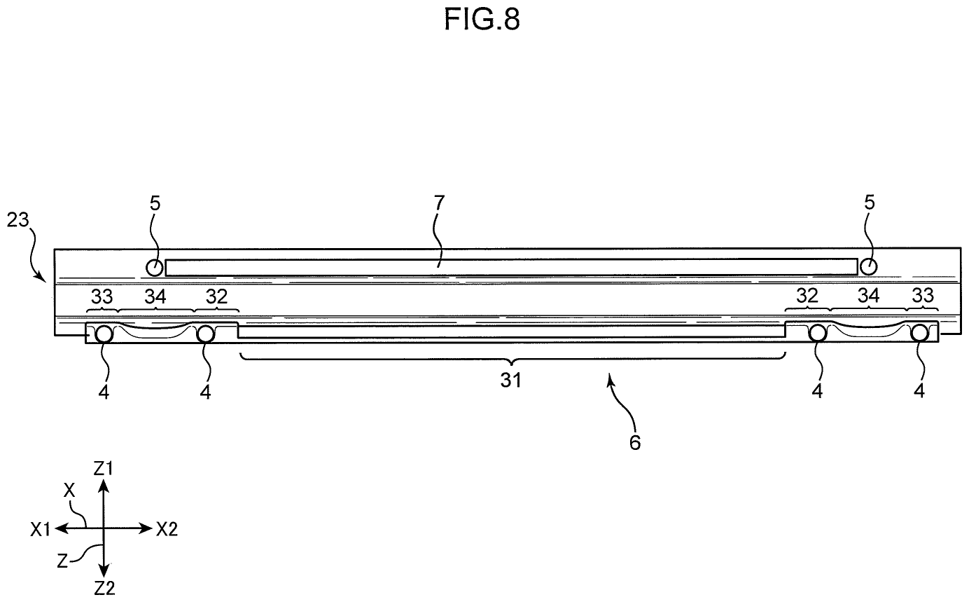

(A) Although the first retainer 6 solely prevents misalignment of both the lower ball 4 and the upper ball 5 in the embodiment, the present invention is not limited thereto. A modification of the present invention may further include, in addition to the first retainer 6, a second retainer 7 as a supplementary retainer for restricting displacement of a plurality of upper balls 5 toward the center in the front-rear direction X of the lower rail 2 as shown in FIG. 8.

The second retainer 7 shown in FIG. 8 is a member having a rod shape and arranged in the other of the lower gap 41 and the upper gap 42, that is, in the upper gap 42 or second gap which is opposite to the lower gap 41 or first gap in which the first retainer 6 is arranged.

The second retainer 7 is arranged between the plurality of upper balls 5 or second balls (two upper balls in FIG. 8) which are located apart from each other in the front-rear direction X, i.e., in a longitudinal direction of the second retainer 7, and are adjacent to the opposite ends (front and rear ends) of the second retainer 7. In FIG. 8, each of the two upper balls 5 is arranged between a region corresponding to a region between two lower balls 4 respectively held by the first ball holding part 32 and the second ball holding part 33. It is noted here that two or more upper balls 5 may be arranged adjacent to the front and rear opposite ends of the second retainer 7 respectively.

The second retainer 7 has such a length as to allow the front and rear opposite ends of the second retainer 7 to come near to the two upper balls 5 located respectively adjacent to these ends of the second retainer 7. Specifically, the length of the second retainer 7 is longer than a distance between the pair of first ball holding parts 32 of the first retainer 6 and shorter than a distance between the pair of the second ball holding parts 33 thereof.

The remaining structures are equivalent to the structures of the sliding device 1 in the embodiment, and thus, descriptions therefor are omitted.

The modification in FIG. 8 further including the second retainer 7 in addition to the first retainer 6 facilitates determination of the position of the upper ball 5 to be a free ball in assembling of a product.

A configuration including the second retainer 7 arranged in the lower gap 41 and the first retainer 6 arranged in the upper gap 42 can exert the same operational effect as that of the modification. This configuration enables the second retainer 7 to restrict misalignment of the lower balls 4 in a free state at the front and rear opposite ends of the second retainer 7 toward the center of the front-rear direction X of the lower rail 2.

### Summary of Embodiment

The embodiment is summarized in the following manner.

A sliding device in the embodiment is a sliding device for supporting a seat slidably. The sliding device includes: a lower rail that is a long member to be fixedly attached to a mount surface over which the seat is arranged; an upper rail that has a portion to be fixedly attached to the seat, is movably guided by the lower rail in a longitudinal direction of the lower rail, and defines an upper gap extending in the longitudinal direction and a lower gap extending in the longitudinal direction below the upper gap in combination with the lower rail; a plurality of lower balls arranged in the lower gap between the lower rail and the upper rail and being rollable in coincidence with a movement of the upper rail; a plurality of upper balls arranged in the upper gap between the lower rail and the upper rail and being rollable in coincidence with a movement of the upper rail; and a first retainer arranged in a first gap being one of the lower gap and the upper gap. The first retainer includes: a main body having a length; a pair of first ball holding parts located at the opposite ends of the main body in a longitudinal direction of the main body for holding first balls, respectively, the first ball being one of the lower ball and the upper ball arranged in the first gap; a pair of second ball holding parts respectively corresponding to the pair of first ball holding parts, the second ball holding part being located further than the first ball holding part with respect to the main body and holding a first ball in a rollable manner; and a pair of connection parts each connecting corresponding one of the pair of first ball holding parts and corresponding one of the pair of second ball holding parts to each other to keep a distance between the center of the first ball held by the first ball holding part and the center of the first ball held by the second ball holding part at a predetermined distance. At least one second ball is arranged in a second gap which is the other of the lower gap and the upper gap and in which the first retainer is not arranged, the second ball being the other of the upper ball and the lower ball and being arranged in a region corresponding to the predetermined distance between the two first balls at each of the opposite ends of the first retainer in the first gap.

The configuration of the sliding device includes the first retainer arranged in the first gap being one of the lower gap and the upper gap, and allows the ball arranged in the second gap in which the first retainer is not arranged to stay in a region corresponding to the predetermined distance without retaining the ball by a retainer or other member. This simple configuration thus achieves prevention of misalignment of the ball.

Specifically, in this configuration, the first retainer is arranged in the first gap being one of the lower gap and the upper gap defined by the lower rail and the upper rail. Two first balls respectively held by the first ball holding part and the second ball holding part at each of the opposite ends of the first retainer support the upper rail and the lower rail, the first ball being one of the lower ball and the upper ball. Each of the lower rail and the upper rail thus has high stiffness in a cross-section in portions supported by the two first balls. Besides, the portions supported by the two first balls exert the high stiffness in the cross-section in the second gap in which the first retainer is not arranged. The second ball that is specifically either of the lower ball and the upper ball and arranged in the second gap without being retained by the first retainer, i.e., the second ball in a free state, is less likely to roll onto the same cross-sectional plane as that of the first balls respectively held by the first ball holding part and the second ball holding part, that is, is less likely to roll to the same position in the longitudinal direction of the lower rail, from the perspective of the property of a ball which has a tendency to roll to a portion having lower stiffness in a cross-section of a rail in a sliding device. In other words, the second ball in the free state has a tendency to stay at a center portion in the predetermined distance between the two first balls respectively held by the first ball holding part and the second ball holding part. By contrast, the lower rail and the upper rail are not supported by the two first balls in the region corresponding to the predetermined distance between the two first balls respectively held by the first ball holding part and the second ball holding part connected by the connection part to each other, and thus has low stiffness in a cross-section in the second gap. The second ball in the free state is hence has a tendency to stay in the region corresponding to the predetermined distance of the connection part. In this configuration, once the second ball, which is the other of the lower ball and the upper ball, in the free state has been arranged at a position in a region corresponding to the region between the two first balls respectively held by the first ball holding part and the second ball holding part, the second ball remains, in the second gap, in the region corresponding to the predetermined distance between the two first ball and has a tendency to stay in the region corresponding to the predetermined distance between the two lower balls without being retained by a retainer or other member. As a result, the sliding device 1 has a simple configuration and enables prevention of misalignment of both the lower ball and the upper ball.

In the sliding device, the predetermined distance, specifically, allows the second ball to travel in the second gap.

In this configuration, the second ball in the free state that is arranged in the second gap which is the other of the lower gap and the upper gap and in which the first retainer is not arranged has a tendency to stay at the center position between two first balls respectively held by the first ball holding part and the second ball holding part in the region corresponding to the predetermined distance between the two first balls. This configuration thus can restrict the displacement of the second ball without providing the retainer in the second gap.

In the sliding device, the predetermined distance is preferably equal to or longer than an alignment length of two of the second balls.

Even when a specific portion has a variation in a component accuracy, this configuration attains a steady force to be applied in a sliding operation by allowing each of the second balls to leave the specific portion having the variation.

In the sliding device, the first retainer is preferably arranged in the lower gap.

In this configuration, the first ball holding part and the second ball holding part at each of the opposite ends of the first retainer hold lower balls being the first balls respectively. Therefore, the single first retainer can stably receive downward loads from the upper rail via four lower balls in total. This consequently allows the upper rail to stably move.

The sliding device may further include a second retainer having a rod shape and arranged in the second gap. The second retainer may be arranged between a plurality of the second balls which are located apart from each other in a longitudinal direction of the second retainer and are adjacent to the opposite ends of the second retainer. This configuration facilitates determination of the position of the second ball to be a free ball in assembling of a product.

Conclusively, the sliding device has a simple configuration and enables prevention of misalignment of a ball.

1. A sliding device for supporting a seat slidably, comprising:
a lower rail that is a long member to be fixedly attached to a mount surface over which the seat is arranged;
an upper rail that has a portion to be fixedly attached to the seat, is movably guided by the lower rail in a longitudinal direction of the lower rail, and defines an upper gap extending in the longitudinal direction and a lower gap extending in the longitudinal direction below the upper gap in combination with the lower rail;
a plurality of lower balls arranged in the lower gap between the lower rail and the upper rail and being rollable in coincidence with a movement of the upper rail;
a plurality of upper balls arranged in the upper gap between the lower rail and the upper rail and being rollable in coincidence with a movement of the upper rail; and
a first retainer arranged in a first gap being one of the lower gap and the upper gap, wherein
the first retainer includes:
a main body having a length;
a pair of first ball holding parts located at the opposite ends of the main body in a longitudinal direction of the main body for holding first balls, respectively, the first ball being one of the lower ball and the upper ball arranged in the first gap;
a pair of second ball holding parts respectively corresponding to the pair of first ball holding parts, the second ball holding part being located further than the first ball holding part with respect to the main body and holding a first ball in a rollable manner; and
a pair of connection parts each connecting corresponding one of the pair of first ball holding parts and corresponding one of the pair of second ball holding parts to each other to keep a distance between the center of the first ball held by the first ball holding part and the center of the first ball held by the second ball holding part at a predetermined distance, and
at least one second ball is arranged in a second gap which is the other of the lower gap and the upper gap and in which the first retainer is not arranged, the second ball being the other of the upper ball and the lower ball and being arranged in a region corresponding to the predetermined distance between the two first balls at each of the opposite ends of the first retainer in the first gap.

2. The sliding device according to claim 1, wherein the predetermined distance allows the second ball to travel in the second gap.

3. The sliding device according to claim 2, wherein the predetermined distance is equal to or longer than an alignment length of two of the second balls.

4. The sliding device according to claim 1, wherein the first retainer is arranged in the lower gap.

5. The sliding device according to claim 1, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.

6. The sliding device according to claim 4, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.

7. The sliding device according to claim 2, wherein the first retainer is arranged in the lower gap.

8. The sliding device according to claim 3, wherein the first retainer is arranged in the lower gap.

9. The sliding device according to claim 2, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.

10. The sliding device according to claim 3, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.

11. The sliding device according to claim 7, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.

12. The sliding device according to claim 8, further comprising a second retainer having a rod shape and arranged in the second gap, wherein
the second retainer is arranged between a plurality of the second balls which are located apart from each other in a longitudinal direction of the second retainer and are adjacent to the opposite ends of the second retainer.
